(19) United States
(12) Patent Application Publication
(10) Pub. No.: US 2025/0331049 A1
(43) Pub. Date: Oct. 23, 2025

(54) BEARER FAILURE RESILIENCY

(71) Applicant: T-Mobile USA, Inc., Bellevue, WA (US)

(72) Inventors: Joel L. Arends, Renton, WA (US); A. Karl Corona, Maple Valley, WA (US); Nassereddine Sabeur, Bellevue, WA (US)

(21) Appl. No.: 18/639,230

(22) Filed: Apr. 18, 2024

(51) Int. Cl. H04W 76/18; H04W 28/18; H04W 48/16; H04W 48/18; H04W 72/543; H04W 72/56

(52) U.S. Cl. CPC H04W 76/18; H04W 28/18; H04W 48/16; H04W 48/18; H04W 72/543; H04W 72/56

(57) ABSTRACT

A device may receive, by a policy function from a call session control function, a request for a dedicated bearer. A device may provide, by the policy function to the call session control function, a response to the request. A device may forward, by the policy function to a bearer management system, the request for the dedicated bearer. A device may determine, by the policy function, an indication of a failure to set up the dedicated bearer. A device may determine, by the policy function, that the call can continue on a default bearer. A device may in response to the determining, taking no action such that the call continues on the default bearer.

### BACKGROUND

Bearers in cellular communications can refer to communication channels or paths used to transmit data between a mobile device and a cellular network. Bearers can be responsible for or play an important role in establishing connections, maintaining data transmission, ensuring quality of service in wireless networks, and so forth.

A cellular network can utilize multiple types of bearers. For example, a default bearer can be a bearer that is established by default when a mobile device connects to a wireless network. Default bearers can be used for general traffic, such as internet browsing, email, text-based messaging, and so forth. However, default bearers may not be suitable for some tasks, such as video conferencing, voice calls, and so forth, which can require higher priority, guaranteed data rates, etc., in order to function optimally.

Dedicated bearers, which can also be known as evolved packet system (EPS) bearers, can be used for specific applications, specific types of network activity, specific users, and so forth. Dedicated bearers can allocate dedicated network resources to ensure that bandwidth, latency, and other quality of service metrics are met.

In some cases, a default bearer, dedicated bearer, or other bearer can fail. Bearer failures can result in call drops, interruptions to data sessions, and so forth.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a diagram that illustrates a dedicated bearer setup failure during call setup according to some implementations.

FIG. 4 is a flowchart that illustrates an example process for handling dedicated bearer setup failure during call setup according to some implementations.

FIG. 5 is a diagram that illustrates an example process for handling dedicated bearer failure during a call (“mid-call”) according to some implementations.

FIG. 6 is a flowchart that illustrates an example process for handling mid-call dedicated barrier failure according to some implementations.

FIG. 7 is a diagram that illustrates a process for handling dedicated bearer setup failure in a 5GC network according to some implementations.

FIG. 8 is a flowchart that illustrates an example process for handling dedicated bearer setup failure during call setup according to some implementations.

FIG. 9 is a diagram that illustrates an example process for handling mid-call dedicated bearer failure according to some implementations.

FIG. 10 is a flowchart that illustrates an example process for handling mid-call dedicated bearer failure according on a 5GC network according to some implementations.

FIG. 11 illustrates an example of dedicated bearer setup failure handling according to some implementations.

FIG. 12 illustrates an example of mid-call dedicated bearer failure handling according to some implementations.

FIG. 13 illustrates an example of mid-call dedicated bearer failure resiliency according to some implementations.

FIG. 14 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Bearers in a wireless communication network are channels that facilitate the transfer of data between user equipment and the wireless communication network. There are several different types of bearers, with different bearers being suited to particular network activities.

Default bearers are the initial communication channels established when a mobile device connects to a network. Default bearers provide connectivity needed for the device to access network services, such as internet browsing, text messaging, call initiation, and so forth.

Default bearers can provide a baseline level of connectivity and typically are associated with services that not especially time-sensitive, data-rate-sensitive, and so forth. Additional bearers can be established based on demand. For example, when browsing the internet, a dedicated bearer can be established to prioritize or otherwise optimize the browsing traffic. In some cases, the default bearer can remain active to ensure continued connectivity, to handle less demanding network tasks, and so forth.

Dedicated bearers can be established for specific applications or services requiring greater or different quality of service (QOS) or having other requirements not met by the default bearer. Dedicated bearers can be created dynamically based on activity. Bearers can have a quality of service class identifier (QCI) associated therewith. The QCI can indicate, for example, whether or not the bearer has a guaranteed bitrate, a priority level of the bearer, a packet delay budget of the bearer, a packet error loss rate, or any combination thereof.

For example, when a user engages in a real-time voice or video call, a dedicated bearer can be established to ensure a maximum latency, minimum throughput, and so forth.

In an idealized scenario, dedicated bearers are created and released dynamically in response to demand. For example, a dedicated bearer can be created for a voice or video call and released at the end of the voice or video call. However, in some cases, creating a dedicated bearer can fail, or a dedicated bearer can fail while in use (e.g., mid-call).

There are many reasons a dedicated bearer can fail, either during setup or while the dedicated bearer is in use. For example, dedicated bearer failure may occur because of network congestion, radio interference, handover issues, quality of service violations, radio resource management issues, authentication or security issues, network component failures, user equipment problems, protocol incompatibility, weather, physical damage to network infrastructure, and so forth. For example, high network congestion can cause the network to struggle to allocate sufficient resources for dedicated bearers, which can result in dropped connections or degraded service quality. Radio interference can be caused by, for example, other electronic devices, physical obstructions, or atmospheric conditions. Handover issues can occur when a mobile device transitions from one cell site to another. Delays or failures in switching between cells can cause a dedicated bearer to be dropped or interrupted. Quality of service violations can occur when the network cannot maintain a particular QOS, for example due to congestion, technical limitations, etc. In some cases, misconfiguration or other problems with radio resource management algorithms can result in dedicated bearer failure. In some cases, network components can fail or user equipment (e.g., smartphones) may be unable to maintain a dedicated bearer.

Typically, when a dedicated bearer fails during setup or mid-call, the call can fail. However, in some cases, it may be possible to transition a call to a default bearer so that the call can continue.

### Wireless Communications System

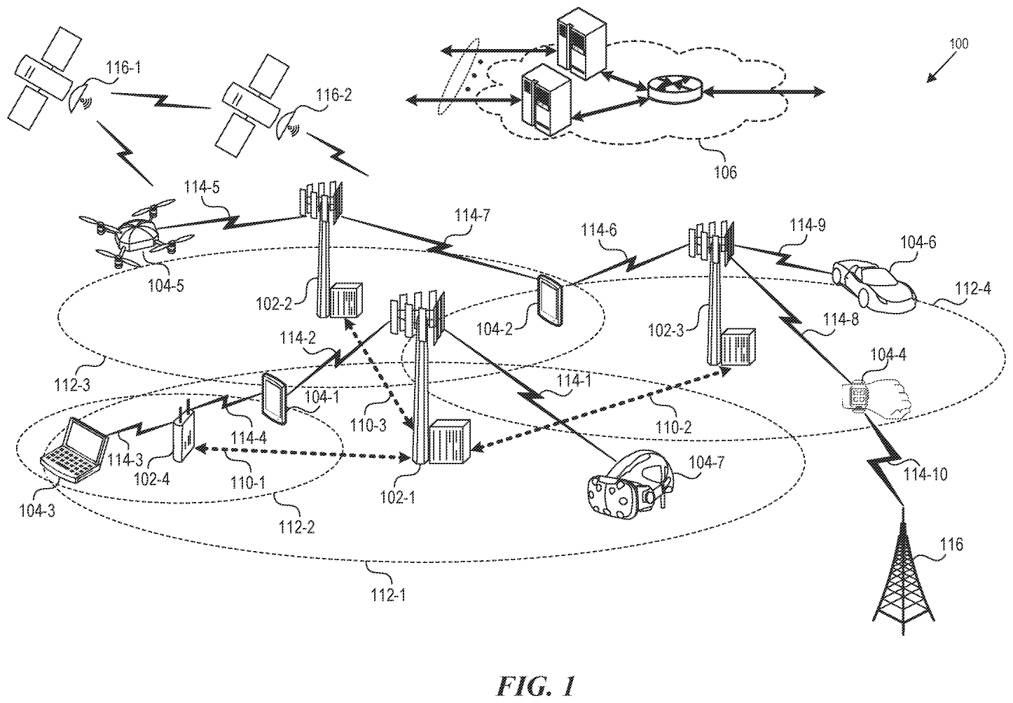

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

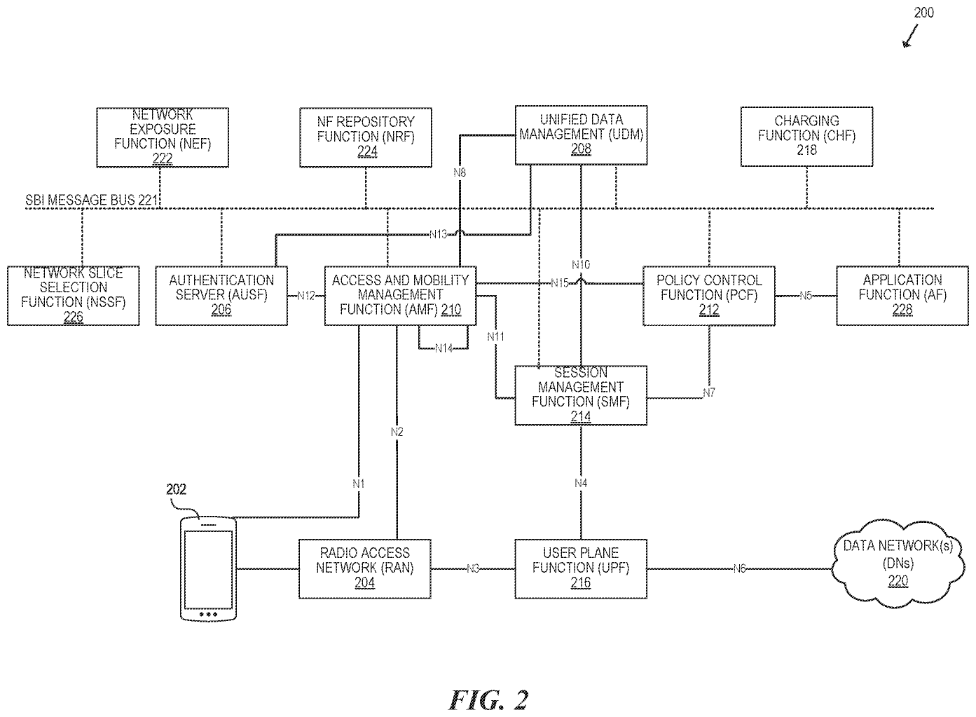

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Dedicated Bearer Failure Resiliency

When a dedicated bearer fails either during initial call setup or during a call, the call can terminate. However, in some cases, the default bearer can still be available and can allow call setup to continue or a call in progress to continue.

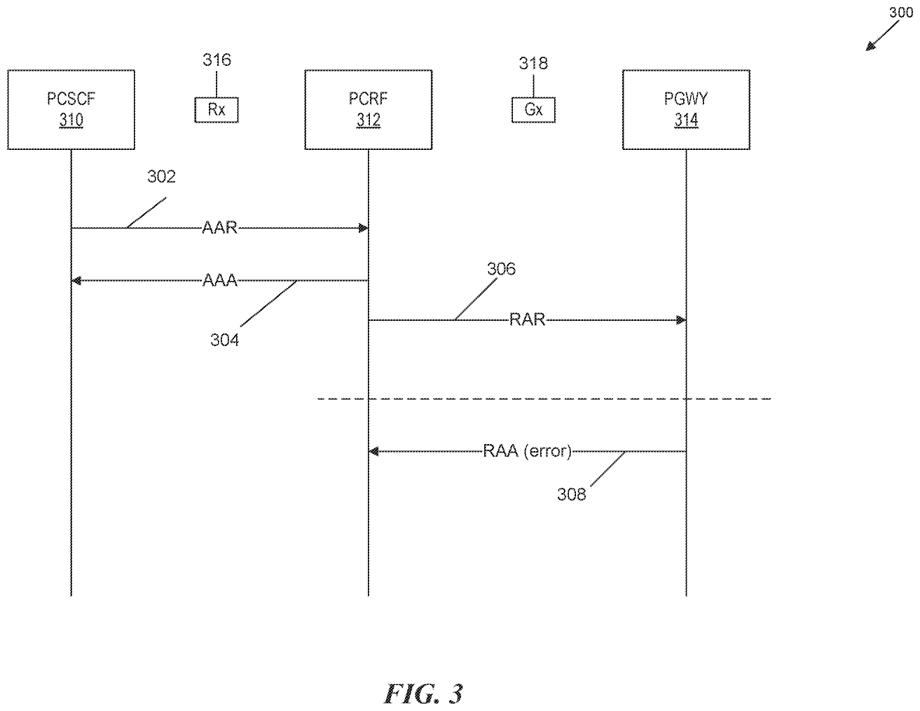

FIG. 3 is a diagram that illustrates a dedicated bearer setup failure during call setup according to some implementations. The process 300 can be implemented on an evolved packet core (EPC) network. At step 302, a proxy call session control function (PCSCF) 310 transmits an authorization-authentication-request (AAR) to a policy and charging rules function (PCRF) 312 over an Rx connector 316. At step 304, the PCRF 312 sends an authorization-authentication-answer (AAA) to the PCSCF 310 via the Rx connector 316. At step 306, the PCRF 312 sends a re-authorization request (RAR) to a packet data network gateway (PGWY) 314 via a Gx connector 318. In the process 300, setup of the dedicated bearer fails at the PGW 314, and at step 308, the PGWY 314 sends a re-authorization answer (RAA) to the PCRF 312 via the Gx connector 318. In response, the PCRF 312 can determine that no action should be taken (e.g., based on an allow/deny list of errors) and the call can continue on a default bearer.

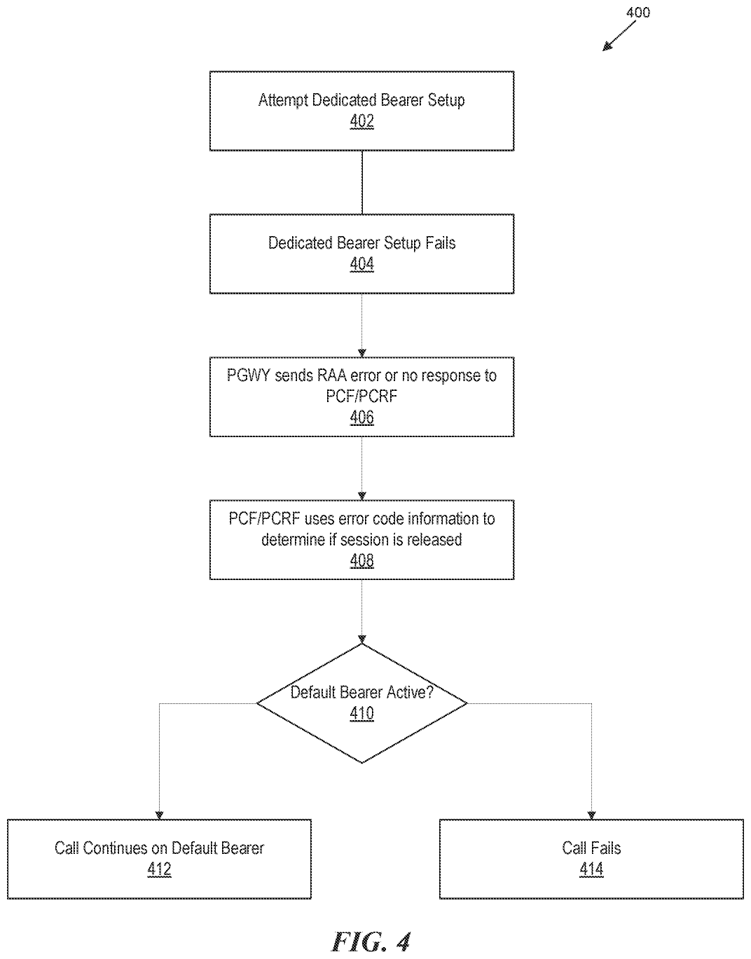

FIG. 4 is a flowchart that illustrates an example process for handling dedicated bearer setup failure during call setup according to some implementations. The process 400 can be implemented on an EPC network. At step 402, the method includes attempting to setup a dedicated bearer for a call (which can be a voice call, video call, etc.). At step 404, the dedicated bearer setup fails. At step 406, a PGWY sends an RAA error or no response to a policy control function (PCF) or PCRF. At step 408 the PCF or PCRF uses the error (or no response) to determine if a call session should be released. At step 410, the method includes determining if a default bearer is still active. If so, the call can continue on the default bearer at step 412. If not, the call can fail at step 414.

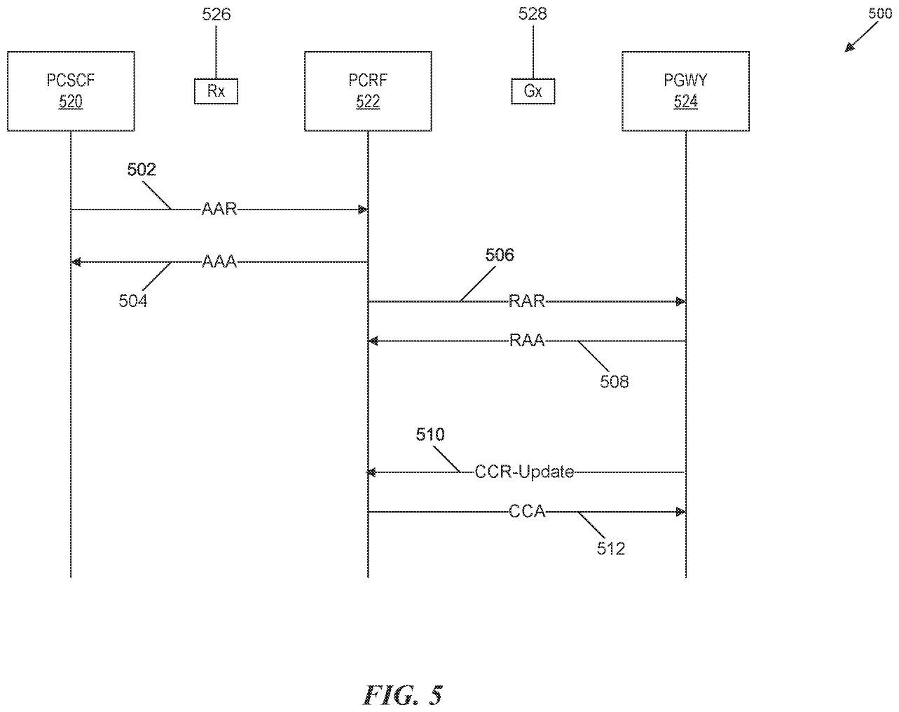

In some cases, setting up a dedicated bearer can succeed, but the dedicated bearer can later fail, for example during a call. FIG. 5 is a diagram that illustrates an example process for handling dedicated bearer failure during a call (“mid-call”). The process 500 can be carried out on an EPC network.

At step 502, a PCSCF 520 sends an AAR to a PCRF 522 via an Rx connector 526. At step 504, the PCRF 522 sends an AAA to the PCSCF 520. At steps 506 and 508, dedicated bearer setup can occur. At step 506, the PCRF 522 sends an RAR to a PGWY 524 via a Gx connector 528. At step 508, the PGWY 524 sends an RAA to the PCRF 522 via the Gx connector 528.

During the call, a dedicated bearer failure can occur. At step 510, the PGWY 524 sends an update message (credit-control-request (CCR) update) to the PCRF 522 via the Gx connector 528 indicating a failure of the dedicated bearer. At step 512, the PCRF 522 sends an acknowledgement (credit-control-answer (CCA)) to the PGWY 524 via the Gx connector 528. In some implementations, the call can continue on the default bearer.

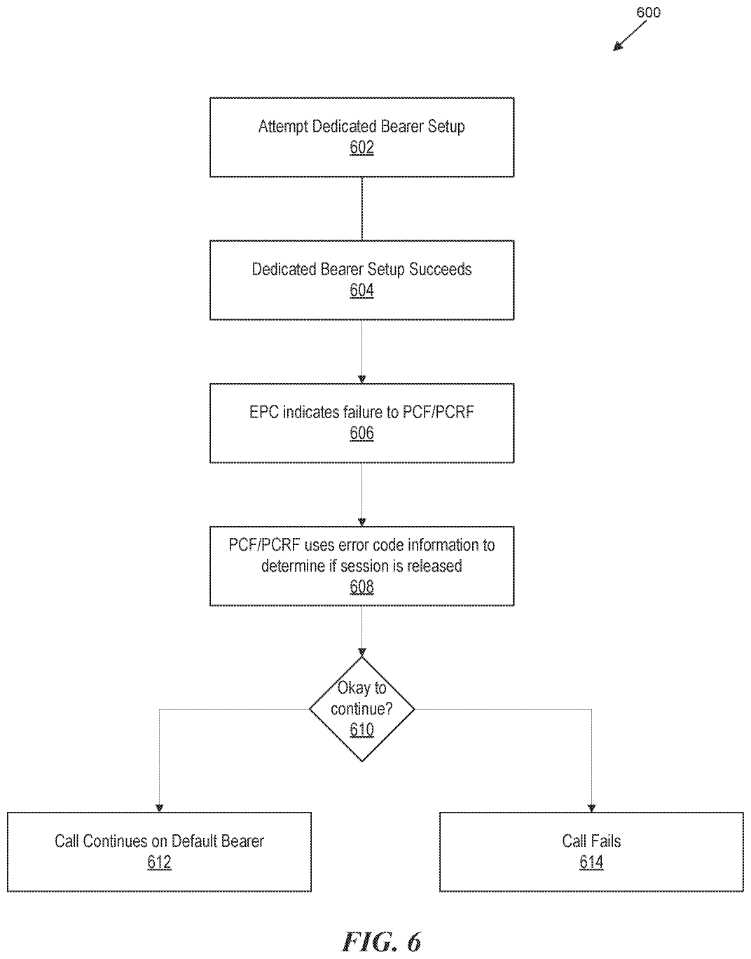

FIG. 6 is a flowchart that illustrates an example process for handling mid-call dedicated bearer failure according to some implementations. At step 602, the method 600 includes attempting to setup a dedicated bearer. At step 604, the dedicated bearer setup succeeds, and the call continues on the dedicated bearer instead of a default bearer (or in addition to the default bearer, for example if an SIP session continues on the default bearer and an RTP session continues on the dedicated bearer). At step 606 the evolved packet core (EPC) indicates a failure of the dedicated bearer to a PCF or PCRF. At step 608, the PCF or PCRF determines, using error code information, if the session should be released, for example by checking an allow/deny list. At decision point 610, the method includes determining if the call can continue. If so, at step 612, the call can continue on the default bearer. If not, the call can fail at step 614.

FIGS. 3-6 relate to wireless networks that use an evolved packet core (EPC) and diameter protocol. In any of the example implementations described above, in some cases, a user equipment can receive a notification of dedicated bearer setup failure or dedicated bearer failure. Similar approaches can be implemented in fifth generation core network (5GC). Instead of the diameter-based protocols used in FIGS. 3-6, message-based protocols (e.g., service-based interfaces) can be in used a 5GC network.

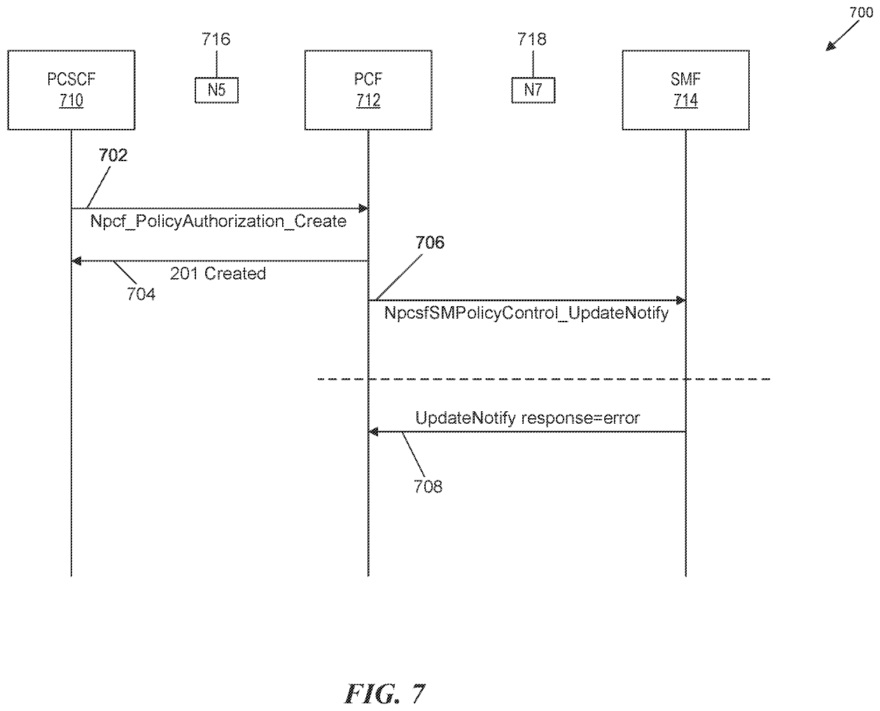

FIG. 7 is a diagram that illustrates a process for handling dedicated bearer setup failure in a 5GC network according to some implementations. At step 702 of the process 700, the process includes a PCSCF 710 sending a request (e.g., Npfc_PolicyAuthorization_Create) to a PCF 712 via an N5 interface 716. At step 704, the PCF 712 sends a HTTP 201 “Created” acknowledgement to the PCSCF 710. At step 706, the PCF 712 sends an update (e.g., NpcsfSMPolicyControl_UpdateNotify) to a session management function (SMF) 714 via an N7 interface 718 requesting a dedicated bearer. In FIG. 7, setup of the dedicated bearer fails. At step 708, the SMF 714 sends a response (e.g., UpdateNotify response=error) to the PCF 712 via the N7 interface 718. In response, the PCF 712 can determine that no action is to be taken, and the call can proceed on the default bearer.

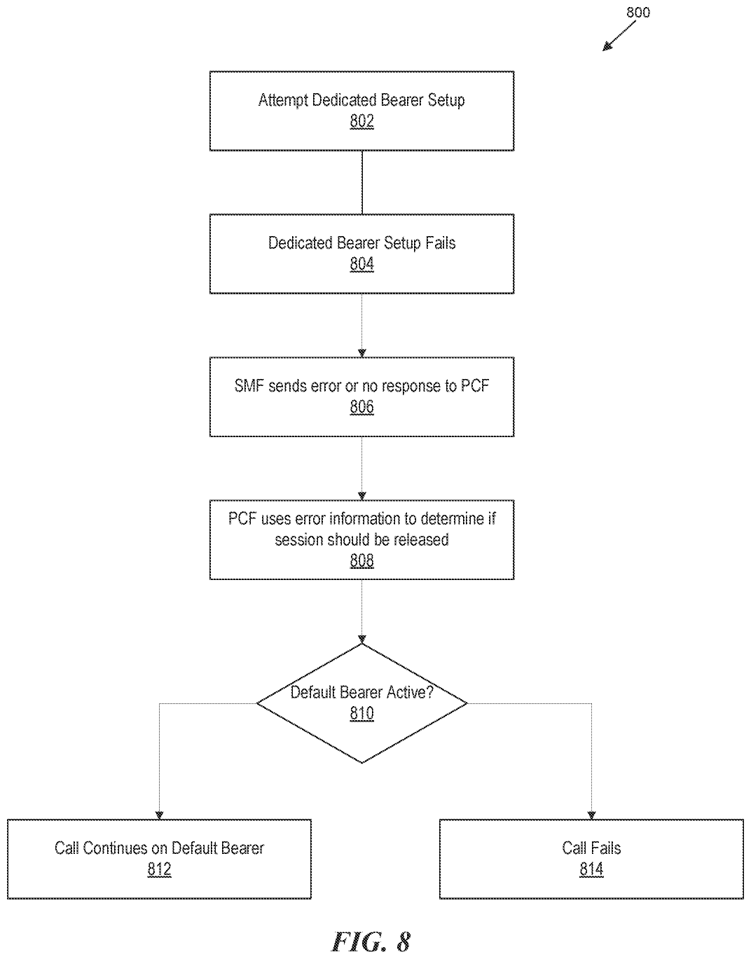

FIG. 8 is a flowchart that illustrates an example process for handling dedicated bearer setup failure during call setup. The process 800 can be implemented on a 5GC network. At step 802, the method includes attempting to set up a dedicated bearer for a call (which can be a voice call, video call, etc.). At step 804, the dedicated bearer setup fails. At step 806, an SMF sends an error message or no response to a PCF. At step 808, the PCF uses the error information (or lack of response in a threshold time) to determine if the session should be released. For example, an error message may indicate that the call is not recoverable or can indicate that the call may be recoverable. At decision point 810, the method includes determining if the default bearer is still active. If the default bearer is not active, the call fails at 814 as the call cannot continue on the default bearer. If, at decision point 810, the default bearer is still active, the method includes, at step 812, continuing the call on the default bearer.

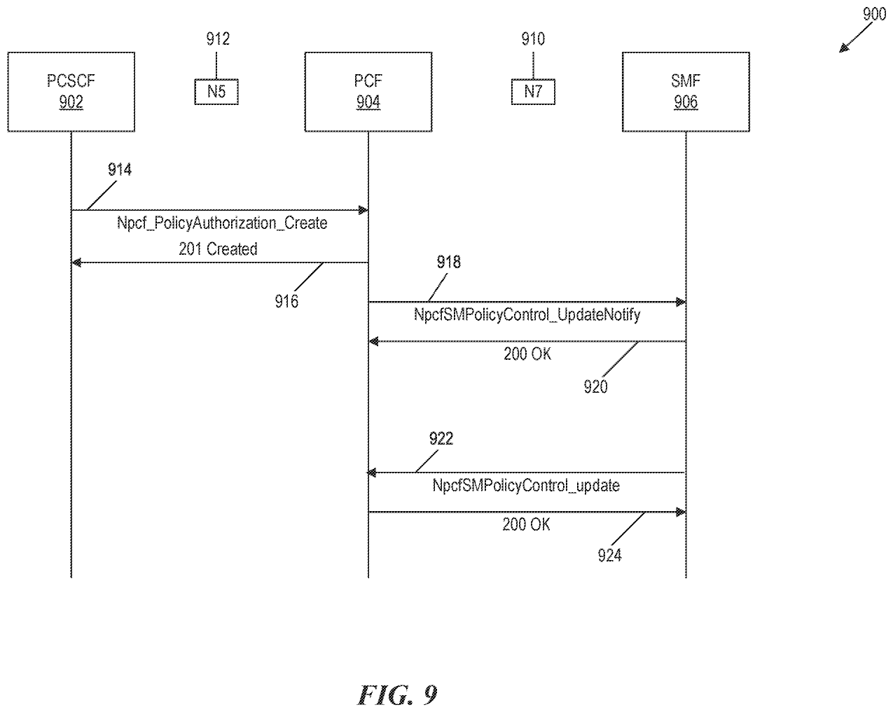

As discussed above in the context of EPC networks, in some cases, setting up a dedicated bearer can succeed, but the dedicated bearer can later fail, for example during a call. FIG. 9 is a diagram that illustrates an example process for handling mid-call dedicated bearer failure. The process 900 can be carried out on a 5GC network.

At step 914, a PCSCF 902 sends a policy authorization create request to a PCF 904 via an N5 interface 912. At step 916, the PCF 904 sends a response (e.g., “201 Created”) to the PCSCF 902 via the interface 912. At step 918, the PCF 904 sends a policy control update notify message to an SMF 906 via an N7 interface 910. At step 920, the SMF 906 sends a response to the PCF 904 via the interface 910 (e.g., “200 OK”). Subsequently, the dedicated bearer can fail, and at step 922, the SMF 906 can send a policy control update to the PCF 904 via the interface 910. At step 924, the PCF 904 can send a response or acknowledgement (e.g., “200 OK”) to the SMF 906 via the interface 910.

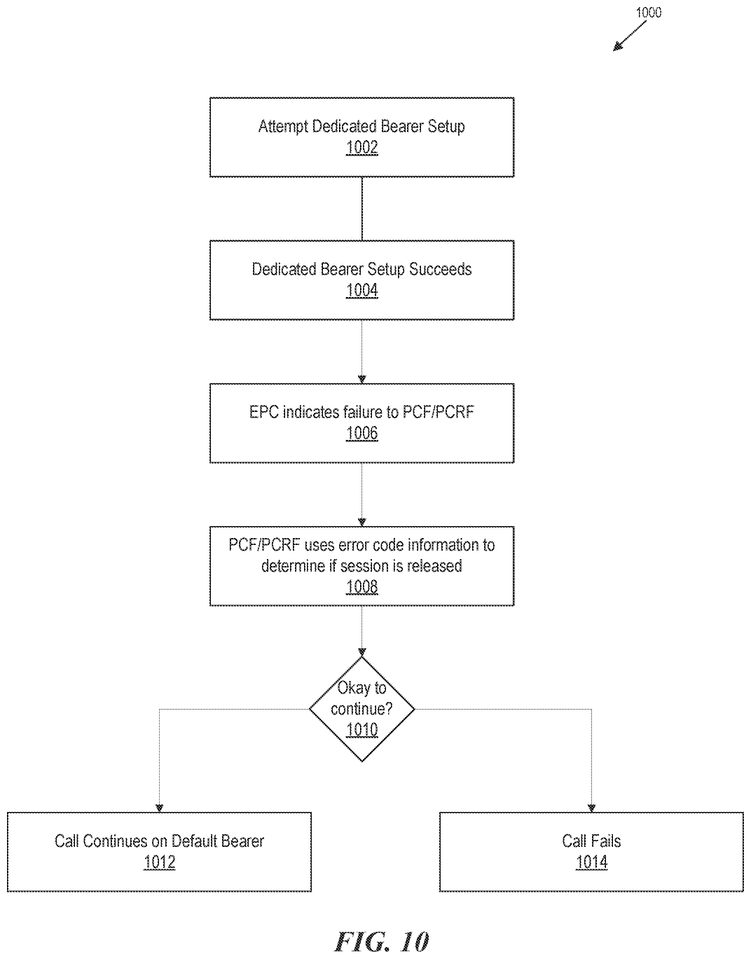

FIG. 10 is a flowchart that illustrates an example process for handling mid-call dedicated bearer failure on a 5GC network according to some implementations. At step 1002, the process 1000 includes attempting to set up a dedicated bearer, for example as described above with reference to FIG. 9. At step 1004, the dedicated bearer setup succeeds and a call continues on the dedicated bearer. For example, a real-time protocol (RTP) portion of the call can transition to the dedicated bearer. At step 1006, the 5GC can indicate failure of the dedicated bearer to the PCF. For example, an SMF can indicate dedicated bearer failure to the PCF. At step 1008, the PCF uses the error information to determine if the session should be released, for example by consulting an allow/deny list. While an error code is described in FIG. 10, in some cases a failure of the dedicated bearer can be determined if the dedicated bearer is unresponsive or non-functional for more than a threshold period of time. At decision point 1010, the process includes determining if the call can continue on the default bearer. If so, at step 1012, the call can transition to the default bearer and continue on the default bearer. If not, the call can fail at step 1014.

In some implementations, a RAN can request setup of a dedicated bearer (e.g., from MME to eNB or from AMF to gNB). If there is a failure between a UE and the RAN, the error can be propagated back to the PCRF/PCF. The PCRF/PCF can then determine handling as described herein. At the UE, the call can continue on a default bearer in some implementations. In any of the above example implementations, in some cases, a notification can be sent to the UE indicating dedicated bearer setup failure and/or dedicated bearer failure. In some implementations, the UE may not receive a notification. In some implementations, the UE can determine dedicated bearer failure based on, for a example, a timer.

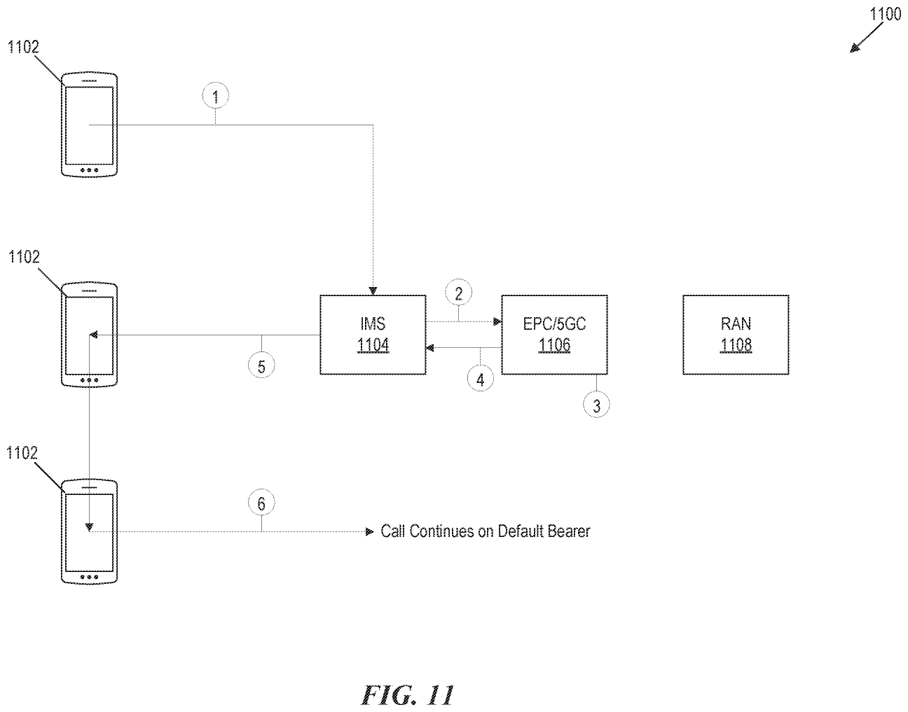

FIG. 11 illustrates an example of dedicated bearer setup failure handling according to an implementation. The process 1100 can be applied to both EPC and 5GC networks, as well as other networks using different technologies that implement similar functionality. At circle (1), user equipment 1102 can be on a default bearer and can start a call on the default bearer by communicating with IP multimedia subsystem (IMS) 1104. At circle (2), the IMS 1104 requests a dedicated bearer from a network core (e.g., EPC or 5GC) 1106. At circle (3), the network core experiences a fault, resulting in failure to setup the dedicated bearer. At circle (4), a PCF in the network core 1106 does not inform the IMS 1104 of the failed resource. At circle (5), the IMS 1104 maintains the call session, and at circle (6), the user equipment 1102 continues the call on the default bearer.

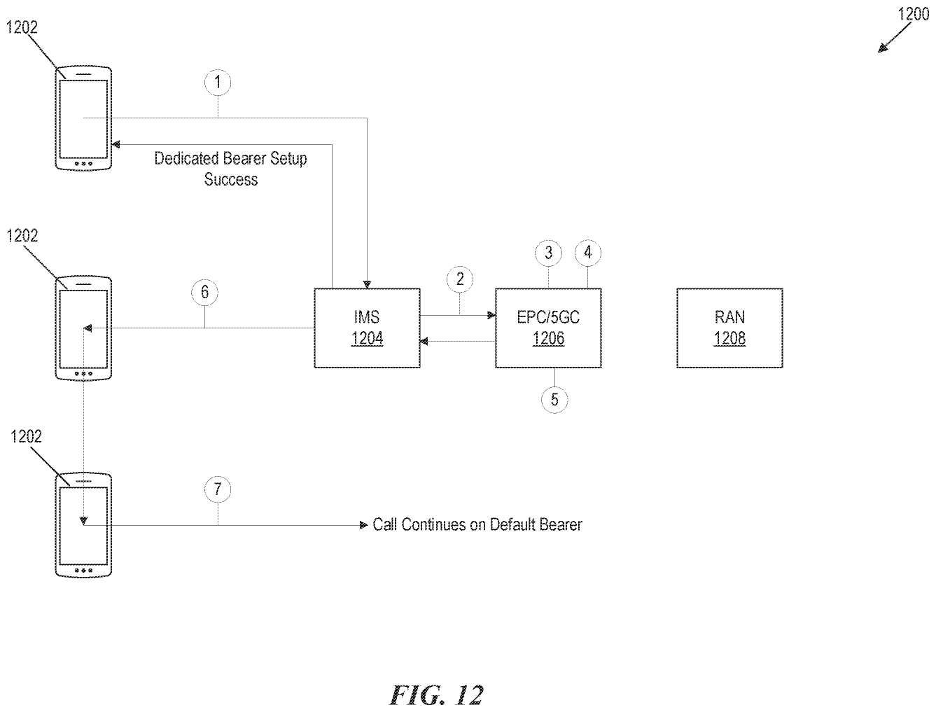

FIG. 12 illustrates an example of mid-call dedicated bearer failure handling according to an implementation. The process 1200 can be applied to both EPC and 5GC networks, as well as other networks using different technologies that implement similar functionality. At circle (1), user equipment 1202 can be on a default bearer and can start a call on the default bearer by communicating with the IMS 1204. At circle (2), the IMS 1204 requests a dedicated bearer from the network core 1206. At circle (3), setup of the dedicated bearer succeeds. At circle (4), the network core 1206 can have a fault resulting in failure of the dedicated bearer. At circle (5), a PCF in the network core 1206 does not inform the IMS 1204 of the failed network resource. At circle (6), the IMS 1204 does not terminate the IMS session for the call. At circle (7), the user equipment 1202 switches to the default bearer for call traffic.

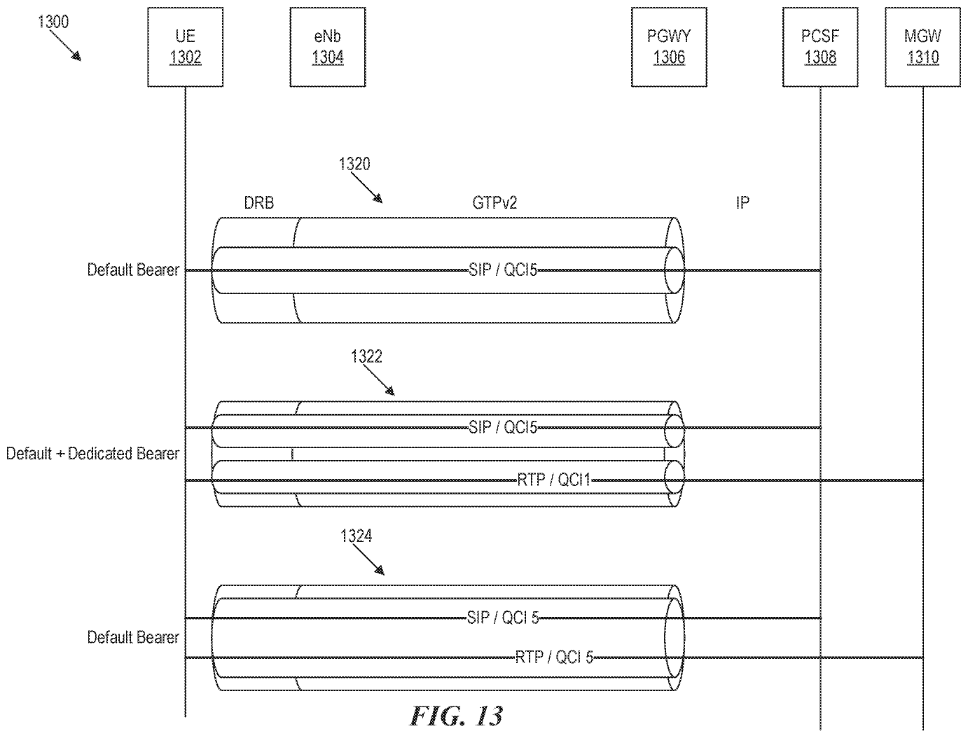

FIG. 13 illustrates an example of mid-call dedicated bearer failure resiliency according to some implementations. The process 1300 can provide for call continuation under circumstances where a dedicated bearer fails mid-call. At 1320, call setup can begin. User equipment 1302 can communicate with eNodeB 1304. Session initiation protocol (SIP) information can be carried on a default bearer with a quality of service class identifier (e.g., QCI5). QCI5 is typically used for IP multimedia subsystem (IMS) signaling and does not have a guaranteed bit rate. At 1322, the SIP session can continue with QCI 5 on the default bearer, and other communication (e.g., RTP data) can be transmitted on a dedicated bearer between the user equipment 1302 and other components (e.g., eNodeB 1304, PGWY 1306, PCSF 1308, and MGW 1310) with a different quality of service class identifier (e.g., QCI1). QCI1 can provided a guaranteed bit rate, making it more suitable for applications where real-time or nearly real-time communication is important, such as voice and video calls. At 1324, the dedicated bearer has failed, and the RTP portion has transitioned back to the default bearer with QCI5.

### Computer System

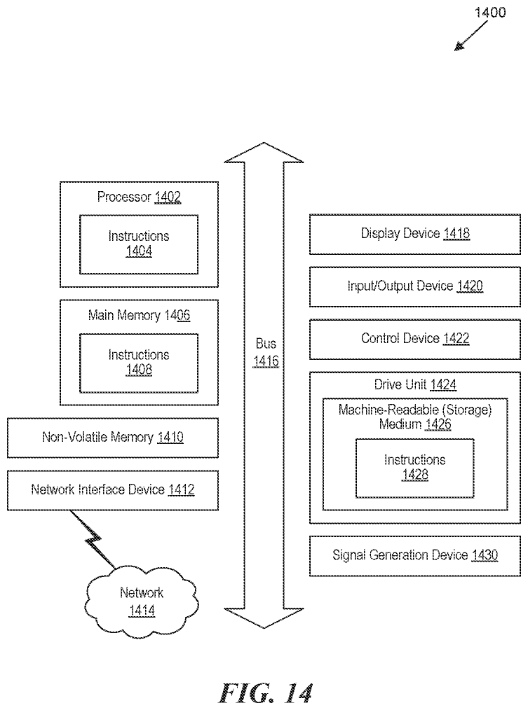

FIG. 14 is a block diagram that illustrates an example of a computer system 1400 in which at least some operations described herein can be implemented. As shown, the computer system 1400 can include: one or more processors 1402, main memory 1406, non-volatile memory 1410, a network interface device 1412, a video display device 1418, an input/output device 1420, a control device 1422 (e.g., keyboard and pointing device), a drive unit 1424 that includes a machine-readable (storage) medium 1426, and a signal generation device 1430 that are communicatively connected to a bus 1416. The bus 1416 represents one or more physical buses and/or point-to-point connections that are connected by appropriate bridges, adapters, or controllers. Various common components (e.g., cache memory) are omitted from FIG. 14 for brevity. Instead, the computer system 1400 is intended to illustrate a hardware device on which components illustrated or described relative to the examples of the figures and any other components described in this specification can be implemented.

The computer system 1400 can take any suitable physical form. For example, the computing system 1400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1400. In some implementations, the computer system 1400 can be an embedded computer system, a system-on-chip (SOC), a single-board computer system (SBC), or a distributed system such as a mesh of computer systems, or it can include one or more cloud components in one or more networks. Where appropriate, one or more computer systems 1400 can perform operations in real time, in near real time, or in batch mode.

The network interface device 1412 enables the computing system 1400 to mediate data in a network 1414 with an entity that is external to the computing system 1400 through any communication protocol supported by the computing system 1400 and the external entity. Examples of the network interface device 1412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1406, non-volatile memory 1410, machine-readable medium 1426) can be local, remote, or distributed. Although shown as a single medium, the machine-readable medium 1426 can include multiple media (e.g., a centralized/distributed database and/or associated caches and servers) that store one or more sets of instructions 1428. The machine-readable medium 1426 can include any medium that is capable of storing, encoding, or carrying a set of instructions for execution by the computing system 1400. The machine-readable medium 1426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1404, 1408, 1428) set at various times in various memory and storage devices in computing device(s). When read and executed by the processor 1402, the instruction(s) cause the computing system 1400 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for handling dedicated bearer setup failure in a wireless communications network for a call comprising:
receiving, by a policy function from a call session control function, a request for a dedicated bearer, the dedicated bearer comprising a first communications channel having a first quality of service class identifier associated therewith;
providing, by the policy function to the call session control function, a response to the request;
forwarding, by the policy function to a bearer management system, the request for the dedicated bearer;
determining, by the policy function, an indication of a failure to set up the dedicated bearer;
determining, by the policy function, that the call can continue on a default bearer, the default bearer comprising a second communications channel having a second quality of service class identifier associated therewith, the second quality of service class identifier different from the first quality of service class identifier; and
in response to the determining, taking no action such that the call continues on the default bearer,
wherein the default bearer is established when a user equipment connects to the wireless communications network,
wherein the first quality of service class identifier includes a guaranteed bit rate and a first priority level, and
wherein the second quality of service class identifier does not include a guaranteed bit rate and includes a second priority level, the second priority level lower than the first priority level.

2. The method of claim 1, wherein determining the indication of the failure to setup the dedicated bearer comprises receiving, by the policy function from the bearer management system, a dedicated bearer setup response, wherein the dedicated bearer response indicates the failure to setup the dedicated bearer.

3. The method of claim 1, wherein determining the indication of the failure to setup the dedicated bearer comprises determining, by the policy function, that a dedicated bearer setup response has not been received for a threshold amount of time.

4. The method of claim 1, wherein determining that the call can continue on the default bearer comprises determining the default bearer is available.

5. The method of claim 1, further comprising causing a notification to be provided to a user equipment of the call that the dedicated bearer setup failed.

6. The method of claim 2, wherein the wireless communications network implements an evolved packet core (EPC) framework,
wherein the request for a dedicated bearer comprises an authorization-authentication-request (AAR),
wherein the response to the request comprises an authorization-authentication-answer (AAA),
wherein forwarding the request for the dedicated bearer comprises transmitting a re-authorization request (RAR), and
wherein the dedicated bearer setup response comprises a re-authorization answer (RAA).

7. The method of claim 2, wherein the wireless communications network comprises a fifth generation core network (5GC),
wherein the request for a dedicated bearer comprises a policy authorization create request,
wherein the response to the request comprises an HTTP 201 “Created” response,
wherein forwarding the request comprising transmitting a policy control update notify request,
wherein the dedicated bearer setup response comprises an update notify response indicating an error.

8. The method of claim 2, wherein the dedicated bearer response comprises an error code,
wherein determining that the call can continue on the default bearer comprises applying a set of rules to the error code.

9. A method for handling dedicated bearer failure in a wireless communications network during a call comprising:
receiving, by a policy control function from a call session control function, a request for a dedicated bearer, the dedicated bearer comprising a first communications channel having a first quality of service class identifier associated therewith;
providing, by the policy function to the call session control function, a response to the request;
forwarding, by the policy function to a bearer management system, a response to the request;
receiving, by the policy function from the bearer management system, a dedicated bearer setup success response;
transitioning the call from a default bearer to the dedicated bearer;
receiving, by the policy function from the bearer management system, an indication of a dedicated bearer failure;
determining, by the policy function based on the indication, that the call can continue on a default bearer, the default bearer comprising a second communications channel having a second quality of service class identifier associated therewith, the second quality of service class identifier different from the first quality of service class identifier; and
transitioning the call to the default bearer,
wherein the default bearer is established when a user equipment connects to the wireless communications network,
wherein the first quality of service class identifier includes a guaranteed bit rate and a first priority level, and
wherein the second quality of service class identifier does not include a guaranteed bit rate and includes a second priority level, the second priority level lower than the first priority level.

10. The method of claim 9, wherein the dedicated bearer response comprises an error code,
wherein determining that the call can continue on the default bearer comprises applying a set of rules to the error code.

11. The method of claim 9, wherein transitioning the call from a default bearer to the dedicated bearer comprises maintaining a session initiation protocol (SIP) session on the default bearer and maintaining a real time protocol (RTP) session on the dedicated bearer.

12. The method of claim 9, further comprising causing a notification of dedicated bearer failure to be provided to a user equipment of the call.

13. A system configured to handle dedicated bearer setup failure in a wireless communications network for a call comprising:
a policy function;
a call session control function; and
a bearer management system,
wherein the system is configured to:
receive, by the policy function from the call session control function, a request for a dedicated bearer, the dedicated bearer comprising a first communications channel having a first quality of service class identifier associated therewith;
provide, by the policy function to the call session control function, a response to the request;
forward, by the policy function to the bearer management system, the request for the dedicated bearer;
determine, by the policy function, an indicate of a failure to set up the dedicated bearer;
determine, by the policy function, that the call can continue on a default bearer, the default bearer comprising a second communications channel having a second quality of service class identifier associated therewith, the second quality of service class identifier different from the first quality of service class identifier; and
in response to the determining, take no action such that the call continues on the default bearer,
wherein the default bearer is established when a user equipment connects to the wireless communications network,
wherein the first quality of service class identifier includes a guaranteed bit rate and a first priority level, and
wherein the second quality of service class identifier does not include a guaranteed bit rate and includes a second priority level, the second priority level lower than the first priority level.

14. The system of claim 13, wherein determining the indication of the failure to set up the dedicated bearer comprises receiving, by the policy function from the bearer management system, a dedicated bearer setup response, wherein the dedicated bearer setup response indicates the failure to setup the dedicated bearer.

15. The system of claim 13, wherein determining the indication of the failure to set up the dedicated bearer comprises determining, by the policy function, that a dedicated bearer setup response has not been received for a threshold period of time.

16. The system of claim 13, wherein determining that the call can continue on the default bearer comprises determining the default bearer is available.

17. The system of claim 13, further comprising causing a notification to be provided to a user equipment of the call that the dedicated bearer setup failed.

18. The system of claim 14, wherein the wireless communications network implements an evolved packet core (EPC) framework,
wherein the request for a dedicated bearer comprises an authorization-authentication-request (AAR),
wherein the response to the request comprises an authorization-authentication-answer (AAA),
wherein forwarding the request for the dedicated bearer comprises transmitting a re-authorization request (RAR), and
wherein the dedicated bearer setup response comprises a re-authorization answer (RAA).

19. The system of claim 14, wherein the wireless communications network comprises a fifth generation core network (5GC),
wherein the request for a dedicated bearer comprises a policy authorization create request,
wherein the response to the request comprises an HTTP 201 “Created” response,
wherein forwarding the request comprising transmitting a policy control update notify request,
wherein the dedicated bearer setup response comprises an update notify response indicating an error.

20. The system of claim 14, wherein the dedicated bearer response comprises an error code,
wherein determining that the call can continue on the default bearer comprises applying a set of rules to the error code.
